(19) United States
(12) Patent Application Publication
(10) Pub. No.: US 2016/0116071 A1
(43) Pub. Date: Apr. 28, 2016

(54) REFRIGERANT COMPRESSOR SHAFT SEAL

(71) Applicant: CARRIER CORPORATION, Farmington, CT (US)

(72) Inventor: Richard T. PANDZIK, Syracuse, NY (US)

(21) Appl. No.: 14/891,174

(22) PCT Filed: May 9, 2014
(86) PCT No.: PCT/US2014/037472

§ 371 Date: Nov. 13, 2015

Related U.S. Application Data
(60) Provisional application No. 61/823,081, filed on May 14, 2013.

(51) Int. Cl. F16J 15/34; F04B 39/00; F25B 31/00; F04B 39/12

(52) U.S. Cl. CPC F16J 15/3496; F04B 39/128; F04B 39/0094; F25B 31/00

(57) ABSTRACT

A shaft sealing mechanism is provided including a first component having a first surface and a second component having a second surface. The first component and the second component are arranged in contact such that the first surface and the second surface form a dynamic interface. The first surface includes a conformable carbon or carbon-graphite material. The second surface includes a rigid, highly polished, silicon carbide material having a plurality of graphite particles embedded therein.

### BACKGROUND OF THE INVENTION

Exemplary embodiments of the invention relate generally to compressor systems, and more particularly to a shaft seal for a crankshaft in a refrigerant compressor system.

Refrigeration systems, such as the type used in transport refrigeration equipment, include, in the simplest form, a compressor, a condenser, an expansion device, and an evaporator serially interconnected to form a closed loop refrigeration circulation path. Various types of compressors used in a refrigeration system include a dynamic seal positioned between rotating components and adjacent stationary components to prevent refrigerant from escaping into the atmosphere.

Oil is used in such compressors to lubricate various parts and interfaces there between. To retain the refrigerant within the compressor, mechanical face seals are commonly used to provide a barrier where the rotating crankshaft penetrates the housing of the compressor. The face seal is typically constructed with a flat, circular, rotating component configured to mate against a flat, circular, stationary component. Acceptably small refrigerant leak rates are generally obtained by maintaining very flat, smooth surfaces at the sealing interface and by introducing oil to the interface. An oil film that forms at the interface not only inhibits the transfer of refrigerant through the interface, but also provides lubrication and reduces potentially damaging friction and wear that may occur during operation of the compressor.

Oil leakage commonly occurs at the sealing interface of the mechanical face seal as described above. If oil is allowed to leak unabated, oil transfer from the compressor can result in environmental or safety issues and/or lead to compressor failure. Typically the face seal is designed in a manner that promotes the development of a substantial oil film, however this may result in undesirable oil leakage from the contained system. Various carbon/graphite and silicon carbide formulations of the rotating component and the stationary component are available that enable seal designs with a very thin oil film thickness, and therefore low oil transfer rates. A key element of a lower leakage seal design is a hard, smooth, surface on one side of the interface, such as a highly polished silicon carbide surface for example, and a somewhat conformable carbon/graphite surface on the other side of the interface. However, if the hard surface is too smooth, the carbon/graphite surface may be damaged as a result of high shear and drag forces that occur on startup before an oil film develops.

### BRIEF DESCRIPTION OF THE INVENTION

According to an aspect of the invention, shaft sealing mechanism is provided including a first component having a first surface and a second component having a second surface. The first component and the second component are arranged in contact such that the first surface and the second surface form a dynamic interface. The first surface includes a conformable carbon or carbon-graphite material. The second surface includes a rigid, highly polished, silicon carbide material having a plurality of graphite particles embedded therein.

According to another aspect of the invention, a refrigerant compressor is provided including a housing. A crankshaft extends through at least a portion of the housing and is configured to rotate relative to the housing. A shaft sealing mechanism is arranged between the housing and the crankshaft to limit refrigerant from leaking from the housing. The shaft sealing mechanism includes a rotating component mounted to the crankshaft. The rotating component includes a first surface. A stationary component is mounted to the housing and is configured to receive the crankshaft. The stationary component has a second surface. The first surface and the second surface are positioned to form a dynamic interface. The first surface includes a conformable carbon or carbon-graphite material. The second surface includes a rigid, highly polished, silicon carbide material having a plurality of graphite particles embedded therein.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view of a compressor according to an embodiment of the invention;

FIG. 2 is an cross-sectional view of a shaft seal cavity of a compressor according to an embodiment of the invention; and

FIG. 3 is a detailed cross-sectional view of a portion of a sealing mechanism arranged within a shaft seal cavity of a compressor according to an embodiment of the invention.

### DETAILED DESCRIPTION OF THE INVENTION

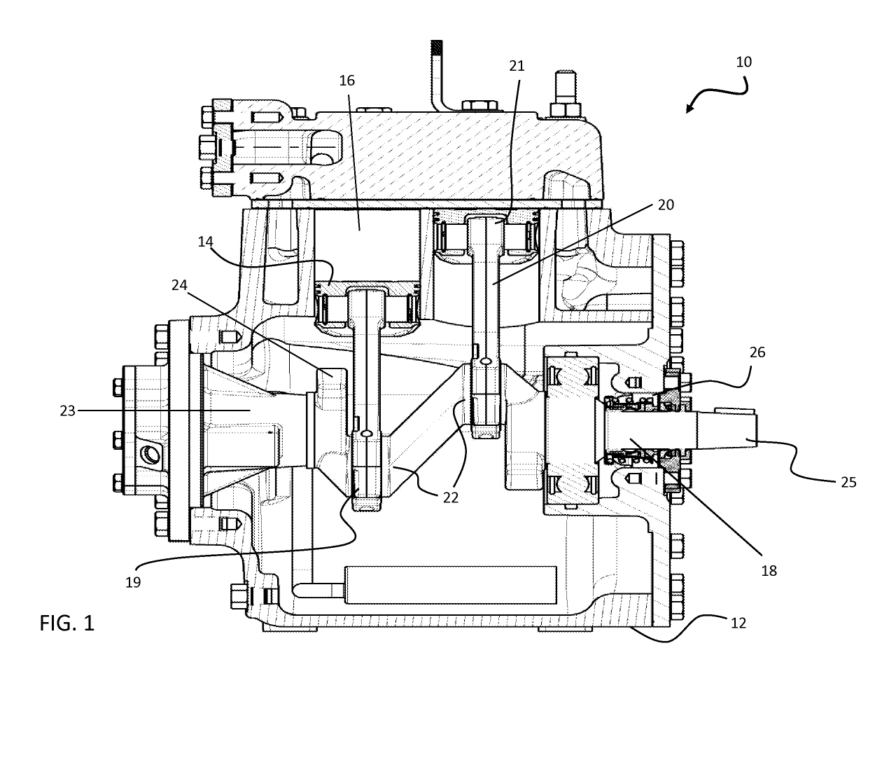

Referring now to FIG. 1, an example of a compressor 10 is illustrated. Though the compressor 10 described and illustrated herein is a reciprocating compressor, other types of refrigerant compressors are within the scope of the invention. The compressor includes a plurality of working pistons 14, each of which is configured to move within a respective cylinder 16 within a housing 12. A first end 19 of a plurality of connecting rods 20 is received about a crankshaft 18 of the compressor, and a second end 21 of each of the plurality of connecting rods 20 is coupled to a piston 14. The first end 19 of each connecting rod 20 may be generally secured to an offset portion 22 of the crankshaft 18. The connecting rods 20 are configured to impart the motion of the crankshaft 18 to each piston 14, such that each of the pistons 14 translates within a respective cylinder 16 as the crankshaft 18 rotates about an axis of rotation R. A counterbalance 24 may be arranged at a first end 23 of the crankshaft 18 to balance any rotational irregularities thereof. A second end 25 of the crankshaft 18 extends through and is configured to rotate within a sleeve (not shown) and a shaft seal cavity 26 of the housing 12.

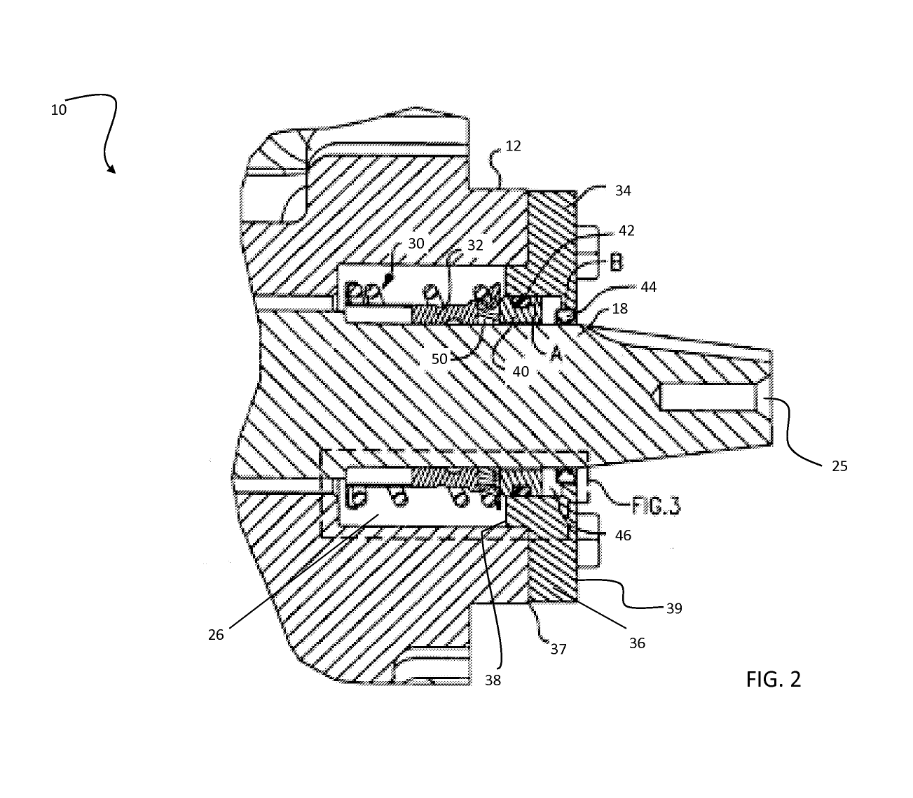

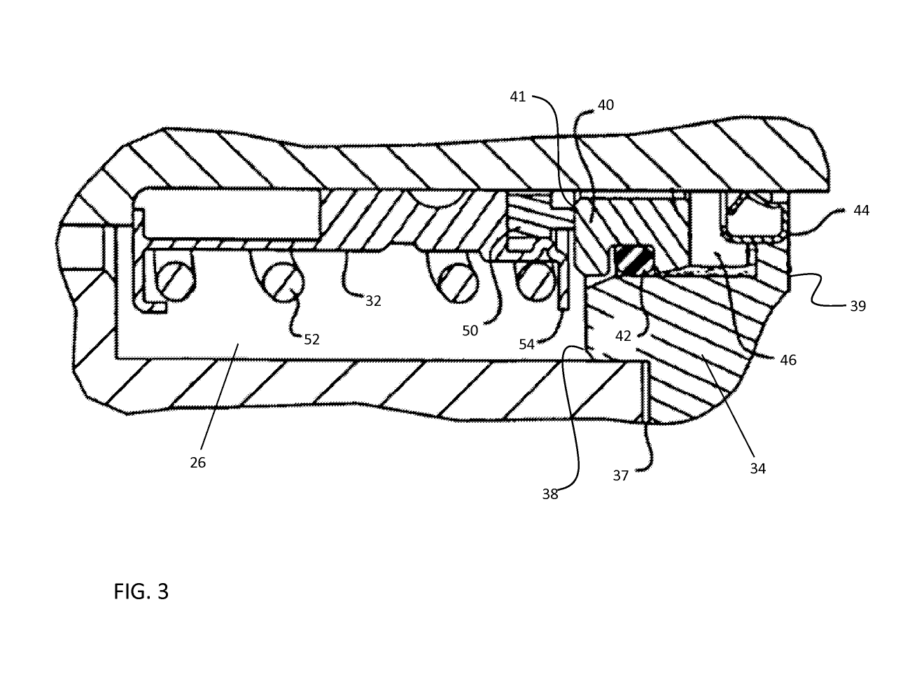

Referring now to FIGS. 2 and 3, a sealing mechanism 30 arranged within the shaft seal cavity 26, near the interface between the second end 23 of the crankshaft 18 and the housing 12, is illustrated in more detail. The sealing mechanism 30 is a mechanical face seal and includes a generally cylindrical body 32 and an adjacent gland plate 34, both having a central bore through which the crankshaft 18 extends. A flange 36 of the gland plate 34 is configured to mount to the housing 12, such as with a plurality of fasteners for example, such that a first end 38 of the gland plate 34 having a diameter smaller than the diameter of the flange 36 is arranged at least partially within the shaft seal cavity 26. In one embodiment, a gland plate gasket 37 is positioned between the outer flange 36 and the housing 12 to prevent seepage there between. Arranged at the first end 38 of the gland plate 34 is a mating ring 40 positioned between the crankshaft 18 and an inner diameter A of the gland plate 34. The mating ring 40 is substantially cylindrical and includes seal 42, such as an O-ring for example, configured to hold the mating ring 40 stationary within the inner diameter A of the gland plate 34 as the crankshaft 18 rotates. A lip seal 44 configured to block dirt, dust, and other debris from entering the shaft seal cavity 26 is located at a second, opposite end 39 of the gland plate 34. The lip seal 44 is positioned generally between the crankshaft 18 and a smaller diameter B of the gland plate 34, such that an inner disc-shaped space 46 is located between the lip seal 44 and the mating ring 34.

A primary ring 50 is arranged at an end of the cylindrical body 32, adjacent the gland plate 34. A biasing mechanism 52, such as a coil spring for example, is wrapped around the exterior of the cylindrical body 32. When installed, the biasing mechanism 52 is preloaded, or in a partially compressed state, such that the biasing mechanism 52 applies a biasing force to a crankshaft seal thrust face 54. The biasing force causes the primary ring 50 to contact and apply an axial load to the counter face 41, or adjacent surface of the mating ring 40, thereby creating a refrigerant seal having a dynamic interface. Oil is generally disposed between the components of the sealing mechanism 30 and the crankshaft 18. The engagement between the mating ring 40 and the primary ring 50 prevents the oil from entering the shaft seal cavity 26. In one embodiment, the gland plate 34 includes a first passage (not shown) connected to a second passage formed generally through the housing 12. If excess oil accumulates within the space 46 between the lip seal 44 and the O-ring 42 of mating ring 40, the excess oil travels through the passages, such as to an internal cavity for example, where the oil is accumulated or absorbed.

The materials selected for the primary ring 50 and the mating ring 40 are critical to the operation of the sealing mechanism 30. The primary ring 50 is generally formed from a relatively soft material, such as carbon graphite for example. Primary rings 50 formed from other known materials are also within the scope of the invention. Exemplary materials used to form the mating ring 40 include cast iron, stainless steel, tungsten carbide, and silicon carbide for example. In one embodiment, the mating ring 40 is formed from a graphite loaded silicon carbide. The graphite within the silicon carbide effectively limits the lower bound of the surface finish attainable for the counter face 41 of the mating ring 40. As a result, a graphite loaded silicon carbide mating ring 40 can be highly polished using conventional lapping techniques to a desired flatness without making the counter face of the mating ring 40 excessively smooth. The graphite inclusions within the silicon carbide provide dry lubricity and minor irregularities that reduce shear forces to below a level that can damage the primary ring 50 biased into contact there with.

Use of a carbon/graphite primary ring 50 and a graphite loaded silicon carbide mating ring 40 results in a cost effective sealing mechanism 30 having a lower leakage rate and improved reliability compared to conventional sealing mechanisms. Because the graphite within the graphite loaded silicon carbide material limits the surface finish thereof, a mating ring 40 formed from such material will be easier to manufacture.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A shaft sealing mechanism comprising:
a first component having a first surface; and
a second component having a second surface, the first component and the second component arranged in contact such that the first surface and the second surface form a dynamic interface, wherein the first surface includes a conformable carbon or carbon-graphite material, and the second surface includes a rigid, highly polished silicon-carbide material having a plurality a graphite particles embedded therein.

2. The shaft sealing mechanism according to claim 1, wherein one of the first component and the second component is configured to rotate.

3. The shaft sealing mechanism according to claim 1, wherein the first surface is impregnated with a resin material or a metallic material.

4. The shaft sealing mechanism according to claim 1, wherein the first component includes a cylindrical body having a primary ring adjacent a first end.

5. The shaft sealing mechanism according to claim 4, wherein the first surface is a portion of the primary ring.

6. The shaft sealing mechanism according to claim 1, wherein the second component includes a gland plate having a mating ring adjacent a first end.

7. The shaft sealing mechanism according to claim 6, wherein the second surface is a portion of the mating ring.

8. A refrigerant compressor comprising:
a housing;
a crankshaft extending through at least a portion of the housing, the crankshaft being configured to rotate relative to the housing;
a shaft sealing mechanism arranged between the housing and the crankshaft to limit refrigerant from leaking from the housing, the shaft sealing mechanism including:
a rotating component mounted to the crankshaft, the rotating component having a first surface; and
a stationary component mounted to the housing and configured to receive the crankshaft, the stationary component having a second surface, the first surface and the second surface being positioned to form a dynamic interface, wherein the first surface includes a conformable carbon or carbon-graphite material, and the second surface includes a rigid, highly polished silicon-carbide material having a plurality a graphite particles embedded therein.

9. The shaft sealing mechanism according to claim 8, wherein the first surface is impregnated with a resin material or a metallic material.

10. The refrigerant compressor according to claim 8, wherein the rotating component includes a cylindrical body having a primary ring adjacent a first end.

11. The refrigerant compressor according to claim 10, wherein the first surface is a portion of the primary ring.

12. The refrigerant compressor according to claim 8, wherein the stationary component includes a gland plate having a mating ring adjacent a first end.

13. The refrigerant compressor according to claim 12, wherein the second surface is a portion of the mating ring.
